(19) United States
(12) Patent Application Publication
(10) Pub. No.: US 2007/0236566 A1
(43) Pub. Date: Oct. 11, 2007

(54) Liquid crystal display having matrix-converting circuit and method of transmitting signals therein

(75) Inventors: Kai-Chieh Chan, Miao-Li (TW); Chien-Fan Tung, Miao-Li (TW); Deng-Tzung Tang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/784,847

(22) Filed: Apr. 9, 2007

(30) Foreign Application Priority Data
Apr. 7, 2006 (TW) 95112471

(51) Int. Cl. H04N 7/18

(52) U.S. Cl. 348/87

(57) ABSTRACT

An exemplary liquid crystal display (3) includes a matrix-converting circuit (316) and an inverse-matrix-converting circuit (327). The matrix-converting circuit receives an RGB (red green blue) signal, and converts the RGB signal to a YCbCr signal. The inverse-matrix-converting circuit converts the YCbCr signal back to the RGB signal. The liquid crystal display requires only a relatively small amount of bandwidth for signal transmission. A related method of transmitting signals in a liquid crystal display is also provided.

### FIELD OF THE INVENTION

The present invention relates to a liquid crystal display (LCD) having a matrix-converting circuit, and a method of transmitting signals in the liquid crystal display.

### GENERAL BACKGROUND

Liquid crystal displays are commonly used as displays for compact electronic apparatuses, because they not only provide good quality images with little power but are also very thin.

Referring to FIG. 6, a typical liquid crystal display 1 includes a scalar board 11 and a liquid crystal module (LCM) 12. The scalar board 11 includes an analog-to-digital converter (ADC) 111, a transition-minimized-differential-signaling (TMDS) unit 112, a multiplexer 113, a scalar 114, and a first low-voltage-differential-signaling (LVDS) unit 115.

The ADC 111 receives an analog RGB (red green blue) signal from an external circuit (not shown), converts the analog RGB signal to a digital RGB signal, and transmits the digital RGB signal to the multiplexer 113. The TMDS unit 112 receives a digital RGB signal from another external circuit (not shown), and encodes the digital RGB signal. That is, the liquid crystal display 1 is capable of selectively receiving analog RGB signals or digital RGB signals. The multiplexer 113 receives a digital RGB signal from either the ADC 111 or the TMDS unit 112, and transmits the digital RGB signal to the scalar 114. The scalar 114 reduces a frequency of the digital RGB signal to a desired value. The first LVDS unit 115 receives the digital RGB signal from the scalar 114, generates an LVDS signal according to the digital RGB signal, and provides the LVDS signal to the liquid crystal module 12.

The liquid crystal module 12 includes a second LVDS unit 121, a timing controller (T-con) 122, a signal driving circuit 123, a scanning driving circuit 124, and a liquid crystal panel 125.

The second LVDS unit 121 receives the LVDS signal from the first LVDS unit 115 of the scalar board 11, and converts the LVDS signal back to the corresponding RGB signal. The T-con 122 receives the RGB signal from the second LVDS unit 121, generates a control signal for the scanning driving circuit 124, and transmits the RGB signal to the signal driving circuit 123. The signal driving circuit 123 and the scanning driving circuit 124 cooperatively drive the liquid crystal panel 125 to display images.

In the liquid crystal display 1, signals are transmitted as RGB signals or LVDS signals representing the RGB signals. In general, RGB signals occupy a large volume, and need to be transmitted through media having a high signal flow capacity. That is, components in the liquid crystal display 1 need to provide a large amount of bandwidth for transmission of the RGB signals. This requirement represents another cost that adds to the overall cost of the liquid crystal display 1.

What is needed, therefore, is a liquid crystal display that can overcome the above-described deficiencies. What is also needed is a method of transmitting RGB signals in the liquid crystal display which can overcome the above-described deficiencies.

### SUMMARY

In one embodiment, a liquid crystal display includes a matrix-converting circuit and an inverse-matrix-converting circuit. The matrix-converting circuit receives an RGB (red blue green) signal, and converts the RGB signal to a YCbCr signal. The inverse-matrix-converting circuit converts the YCbCr signal back to the RGB signal.

Other aspects, novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of different embodiments of the present invention. In the drawings, like reference numerals designate corresponding parts throughout various views, and all the views are schematic.

FIG. 1 is a block diagram of a liquid crystal display according to a first embodiment of the present invention.

FIG. 2 is a block diagram of a liquid crystal display according to a second embodiment of the present invention.

FIG. 3 is a block diagram of a liquid crystal display according to a third embodiment of the present invention.

FIG. 4 is a block diagram of a liquid crystal display according to a fourth embodiment of the present invention.

FIG. 5 is a block diagram of a liquid crystal display according to a fifth embodiment of the present invention.

FIG. 6 is a block diagram of a conventional liquid crystal display.

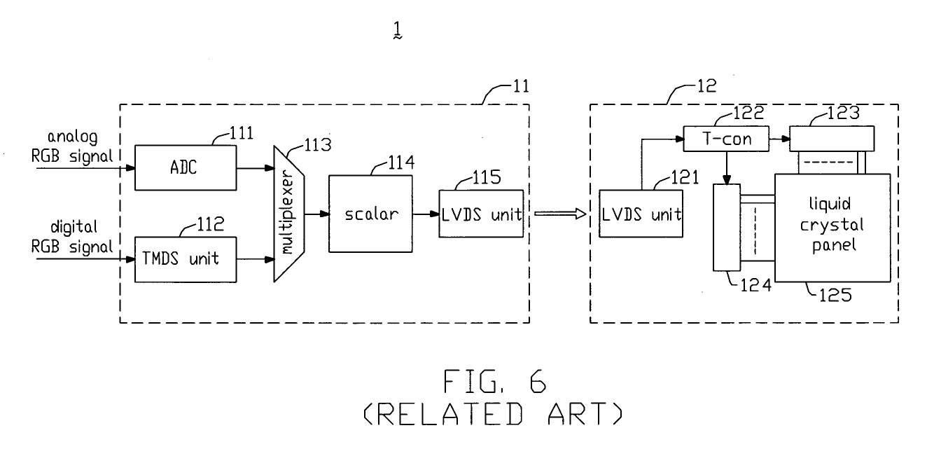

### DETAILED DESCRIPTION OF PREFERRED EMBODIMENTS

Reference will now be made to the drawings to describe various embodiments of the present invention in detail.

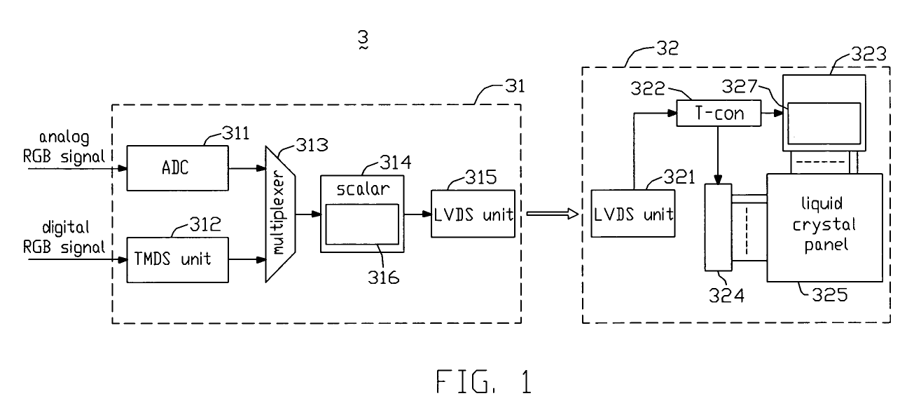

Referring to FIG. 1, a liquid crystal display 3 according to a first embodiment of the present invention is shown. The liquid crystal display 3 includes a scalar board 31 and a liquid crystal module 32.

The scalar board 31 includes an ADC 311, a TMDS unit 312, a multiplexer 313, a scalar 314 having a matrix-converting circuit 316, and a first LVDS unit 315.

The ADC 311 receives an analog RGB signal from an external circuit (not shown), converts the analog RGB signal to a digital RGB signal, and transmits the digital RGB signal to the multiplexer 313. The TMDS unit 312 receives a digital RGB signal from another external circuit (not shown), and encodes the digital RGB signal for the multiplexer 313. That is, the liquid crystal display 3 is capable of selectively receiving analog RGB signals or digital RGB signals. The multiplexer 314 receives a digital RGB signal from either the ADC 311 or the TMDS unit 312, and transmits the digital RGB signal to the scalar 314 having the matrix-converting circuit 316. The matrix-converting circuit 316 converts the RGB signal to a YCbCr signal. In the expression YCbCr, Y represents a luminance of a red, a green or a blue sub-pixel of a liquid crystal panel 325 of the liquid crystal module 32, Cb represents chroma of the color blue, and Cr represent chroma of the color red. The first LVDS unit 315 receives the YCbCr signal from the matrix-converting circuit 316, and converts the YCbCr signal to an LVDS signal.

The liquid crystal module 32 includes a second LVDS unit 321, a T-con 322, a signal driving circuit 323 having an inverse-matrix-converting circuit 327, and a scanning driving circuit 324.

The second LVDS unit 321 of the liquid crystal module 32 receives the LVDS signal from the first LVDS unit 315 of the scalar board 31, and converts the LVDS signal back to the corresponding YCbCr signal. The T-con 322 receives the YCbCr signal from the second LVDS unit 321, and transmits the YCbCr signal to the signal driving circuit 323. The T-con 322 also generates a control signal for the scanning driving circuit 324. The inverse-matrix-converting circuit 327 of the signal driving circuit 323 converts the YCbCr signal back to the corresponding RGB signal. The scanning driving circuit 324 and the signal driving circuit 323 cooperatively drive the liquid crystal panel 325 to display images.

The liquid crystal display 3 includes the matrix-converting circuit 316, which converts the RGB signal requiring a large amount of bandwidth to the YCbCr signal. In general, the YCbCr signal requires a small amount of bandwidth. When the YCbCr signal is sampled at 4:2:0 or 4:1:1, an amount of signal flow of the liquid crystal display 3 can be reduced to half that of a conventional liquid crystal display, as calculated according to standards defined by the International Telecommunication Union (ITU). In an alternative embodiment, when the YCbCr signal is sampled at 4:2:2, an amount of the signal flow of the liquid crystal display 3 can be reduced to one-third of that of a conventional liquid crystal display. Therefore unlike conventional liquid crystal displays, the liquid crystal display 3 can use low-cost components having smaller capacities for signal transmittance. Thus, an overall cost of the liquid crystal display 3 can be reduced.

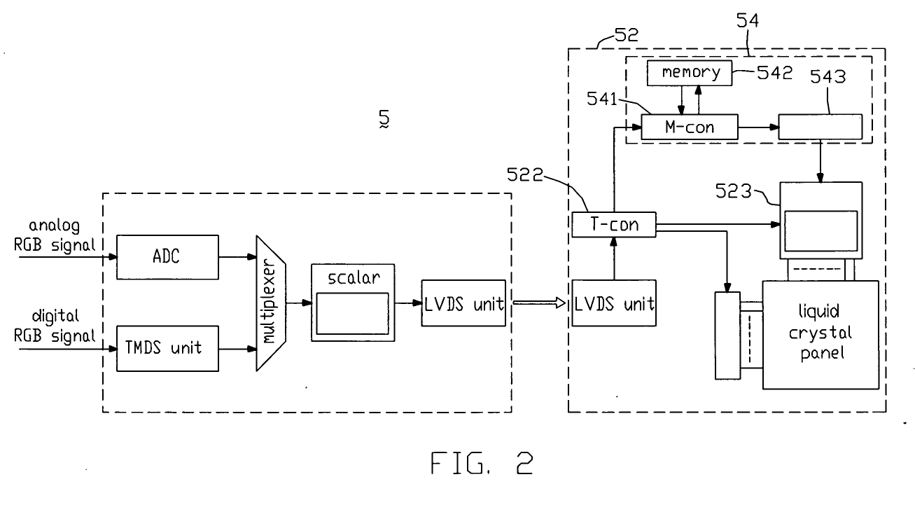

Referring to FIG. 2, a liquid crystal display 5 according to a second embodiment of the present invention is similar to the liquid crystal display 3. However, the liquid crystal display 5 includes a liquid crystal module 52. The liquid crystal module 52 includes an overdrive circuit 54, a T-con 522, a signal driving circuit 523, and a liquid crystal panel. The overdrive circuit 54 includes a memory controller (M-con) 541, a memory 542, and a signal processing unit 543. The signal driving circuit 523 has an inverse-matrix-converting circuit (not labeled) therein. The overdrive circuit 54 is connected to the T-con 522. In particular, the M-con 541 receives a first frame YCbCr signal from the T-con 522, and stores the first frame YCbCr signal in the memory 542. The M-con 541 reads the first frame YCbCr signal from the memory 542, and transmits the first frame YCbCr signal to the signal processing unit 543 together with a next frame YCbCr signal. The inverse-matrix-converting circuit of the signal processing unit 543 converts the two frames of YCbCr signals back to RGB signals, and transmits the RGB signals to the liquid crystal panel. The liquid crystal display 5 has advantages similar to those described above in relation to the liquid crystal display 3.

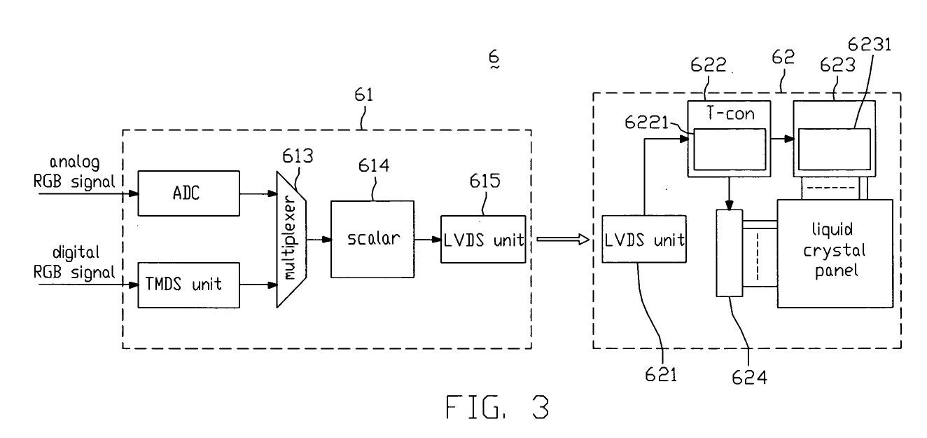

Referring to FIG. 3, a liquid crystal display 6 according to a third embodiment of the present invention is similar to the liquid crystal display 3. However, the liquid crystal display 6 includes a scalar board 61 and a liquid crystal module 62. The scalar board 61 includes a scalar 614 connected to a multiplexer 613 and a first LVDS unit 615, respectively. The liquid crystal module 62 includes a T-con 622 having a matrix-converting circuit 6221, a second LVDS unit 621, a signal driving circuit 623 having an inverse-matrix-converting circuit 6231, a scanning driving circuit 624, and a liquid crystal panel. The T-con 622 is connected to the second LVDS unit 621, the signal driving circuit 623, and the scanning driving circuit 624. The liquid crystal display 6 has advantages similar to those described above in relation to the liquid crystal display 3.

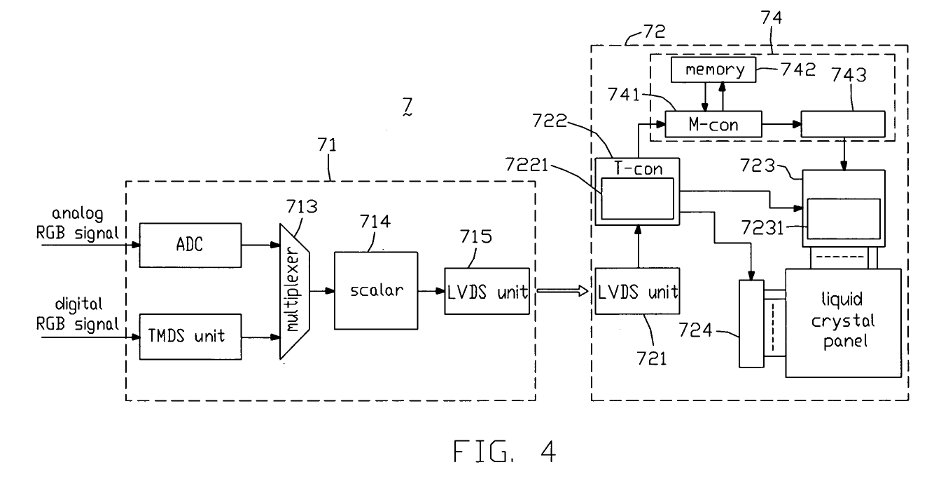

Referring to FIG. 4, a liquid crystal display 7 according to a fourth embodiment of the present invention is similar to the liquid crystal display 6. However, the liquid crystal display 7 includes a scalar board 71 and a liquid crystal module 72. The scalar board 71 includes a scalar 714 connected to a multiplexer 713 and to a first LVDS unit 715. The liquid crystal module 72 includes a second LVDS unit 721, a T-con 722 having a matrix-converting circuit 7221, an overdrive circuit 74, a signal driving circuit 723 having an inverse-matrix-converting circuit 7231, a scanning driving circuit 724, and a liquid crystal panel. The overdrive circuit 74 includes an M-con 741, a memory 742, and a signal processing unit 743. The T-con 722 having the matrix-converting circuit 7221 is connected to the second LVDS unit 721, the M-con 741 of the overdrive circuit 74, the signal driving circuit 723, and the scanning driving circuit 724. The liquid crystal display 7 has advantages similar to those described above in relation to the liquid crystal display 6.

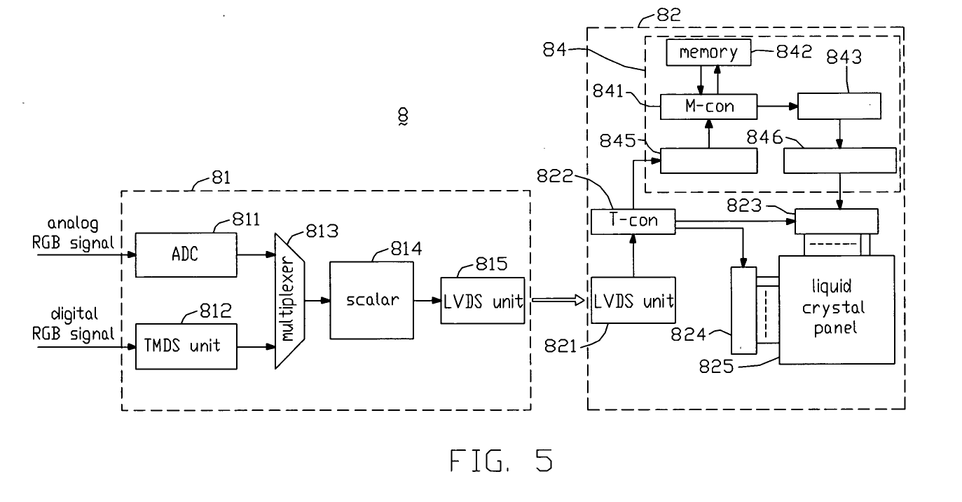

Referring to FIG. 5, a liquid crystal display 8 according to a fifth embodiment of the present invention is similar to the liquid crystal display 3. The liquid crystal display 8 includes a scalar board 81 and a liquid crystal module 82. The scalar board 81 includes an ADC 811, a TMDS unit 812, a multiplexer 813, a scalar 814, and a first LVDS unit 815.

The ADC 811 receives an analog RGB signal from an external circuit (not shown), converts the analog RGB signal to a digital RGB signal, and transmits the digital RGB signal to the multiplexer 813. The TMDS unit 812 receives a digital RGB signal from another external circuit (not shown), and encodes the digital RGB signal for the multiplexer 813. That is, the liquid crystal display 8 is capable of selectively receiving analog RGB signals or digital RGB signals. The multiplexer 813 receives a digital RGB signal from either the ADC 811 or the TMDS unit 812, and transmits the digital RGB signal to the scalar 814. The scalar 814 reduces a frequency of the digital RGB signal to a desired value. The first LVDS unit 815 receives the digital RGB signal from the scalar 814, generates an LVDS signal according to the digital RGB signal, and transmits the LVDS signal to the liquid crystal module 82.

The liquid crystal module 82 includes a second LVDS unit 821, a T-con 822, a signal driving circuit 823, a scanning driving circuit 824, an overdrive circuit 84, and a liquid crystal panel 825.

The second LVDS unit 821 of the liquid crystal module 82 receives the LVDS signal from the first LVDS unit 815 of the scalar board 81, and converts the LVDS signal back to the corresponding RGB signal. The T-con 822 receives the RGB signal from the second LVDS unit 821, and transmits the RGB signal to the signal driving circuit 823. The T-con 822 also generates a control signal for the scanning driving circuit 824.

The overdrive circuit 84 includes an M-con 841, a memory 842, a signal processing unit 843, a matrix-converting circuit 845, and an inverse-matrix-converting circuit 846. The matrix-converting circuit 845 receives the RGB signal from the T-con 822, generates a first frame YCbCr signal, and transmits the first frame YCbCr signal to the M-con 841. The first frame YCbCr signal can be sampled at 4:2:2, 4:2:0, or 4:1:1. The M-con 841 stores the first frame YCbCr signal to the memory 842, reads the first frame YCbCr signal from the memory 842, and transmits the first frame YCbCr signal to the signal processing unit 843 together with a next frame YCbCr signal. The signal processing unit 843 transmits the two frames of YCbCr signals to the inverse-matrix-converting circuit 846. The inverse-matrix-converting circuit 846 receives the two frames of YCbCr signals, converts the two frames of YCbCr signals back to the corresponding RGB signals, and transmits the RGB signals to the signal driving circuit 823. The scanning driving circuit 824 and the signal driving circuit 823 cooperatively drive the liquid crystal panel 825 to display images. The liquid crystal display 8 has advantages similar to those described above in relation to the liquid crystal display 3.

An exemplary method of transmitting RGB signals in a liquid crystal display includes: receiving and transmitting the RGB signals; converting the RGB signals to YCbCr signals, and transmitting the YCbCr signals; and converting the YCbCr signals back to the RGB signals. In this exemplary method, the liquid crystal display can for example be any of the above-described liquid crystal displays 3, 5, 6, 7 or 8.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A liquid crystal display comprising:
a matrix-converting circuit for receiving an RGB (red green blue) signal, and converting the RGB signal to a YCbCr signal; and
an inverse-matrix-converting circuit for converting the YCbCr signal back to the RGB signal.

2. The liquid crystal display as claimed in claim 1, further comprising a scalar, wherein the matrix-converting circuit is comprised in the scalar.

3. The liquid crystal display as claimed in claim 2, further comprising a signal driving circuit, wherein the inverse-matrix-converting circuit is comprised in the signal driving circuit.

4. The liquid crystal display as claimed in claim 3, further comprising an overdrive circuit connected to the signal driving circuit, wherein the overdrive circuit receives and stores a first frame YCbCr signal, and transmits the first frame YCbCr signal to the signal driving circuit together with a next frame YCbCr signal.

5. The liquid crystal display as claimed in claim 1, further comprising a timing controller, wherein the matrix-converting circuit is comprised in the timing controller.

6. The liquid crystal display as claimed in claim 5, further comprising a signal driving circuit, wherein the inverse-matrix-converting circuit is comprised in the signal driving circuit.

7. The liquid crystal display as claimed in claim 6, further comprising an overdrive circuit connected to the signal driving circuit, wherein the overdrive circuit receives and stores a first frame YCbCr signal, and transmits the first frame YCbCr signal to the signal driving circuit together with a next frame YCbCr signal.

8. The liquid crystal display as claimed in claim 1, further comprising an overdrive circuit, wherein the matrix-converting circuit is comprised in the overdrive circuit.

9. The liquid crystal display as claimed in claim 8, wherein the inverse-matrix-converting circuit is also comprised in the overdrive circuit.

10. The liquid crystal display as claimed in claim 9, wherein the overdrive circuit further comprises a memory controller connected to the matrix-converting circuit, a memory connected to the memory controller, and a signal processing unit connected to the memory controller and the inverse-matrix-converting circuit.

11. The liquid crystal display as claimed in claim 10, wherein the memory controller receives a first frame YCbCr signal from the matrix-converting circuit, stores the first frame YCbCr signal to the memory, reads the first frame YCbCr signal from the memory, and transmits the first frame YCbCr signal to the signal processing unit together with a next frame YCbCr signal, and the signal processing unit transmits the two frames of YCbCr signals to the inverse-matrix-converting circuit.

12. The liquid crystal display as claimed in claim 1, wherein the liquid crystal display is capable of selectively receiving analog RGB signals or digital RGB signals.

13. The liquid crystal display as claimed in claim 1, wherein the YCbCr signal is sampled at 4:2:0, 4:1:1 or 4:2:2.

14. A method of transmitting signals in a liquid crystal display, the method comprising:
receiving and transmitting RGB (red green blue) signals;
converting the RGB signals to YCbCr signals, and transmitting the YCbCr signals; and
converting the YCbCr signals back to the RGB signals.

15. The method as claimed in claim 14, wherein the YCbCr signals are sampled at 4:2:0, 4:1:1, or 4:2:2.

16. The method as claimed in claim 14, wherein the RGB signals are converted to the YCbCr signals by a matrix-converting circuit.

17. The method as claimed in claim 16, wherein the YCbCr signals are converted back to the RGB signals by an inverse-matrix-converting circuit.

18. A liquid crystal display comprising:
a first circuit configured for receiving a digital signal occupying a first amount of bandwidth, and converting the digital signal to a non-digital signal occupying a second amount of bandwidth, wherein the second amount of bandwidth is less than the first amount of bandwidth; and
a second circuit configured for converting the non-digital signal back to the digital signal.
